(19) United States
(12) Patent Application Publication
(10) Pub. No.: US 2005/0106310 A1
(43) Pub. Date: May 19, 2005

(54) Designed particle agglomeration

(76) Inventors: John Henry Green, Oxford, PA (US); Marc Martin Sommer, Burghrusen (DE); Douglas Eric Spahr, Wilmington, DE (US); Norman Joseph Wagner, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/882,819

(22) Filed: Jul. 1, 2004

Related U.S. Application Data
(60) Provisional application No. 60/484,363, filed on Jul. 2, 2003.

(51) Int. Cl. C09C 1/44

(52) U.S. Cl. 426/650

(57) ABSTRACT

This invention describes a process for agglomerating particles into fractal structures of designed size and distribution. The present invention relates generally to the production of particle agglomerates, tailored to a specific size and structure, from initially dispersed particles.

### FIELD OF THE INVENTION

This invention describes a process for agglomerating particles into fractal structures of designed size and distribution in a dispersion. The present invention relates generally to the production of a slurry of particle agglomerates, tailored to a specific size and structure, and from dispersed particles. More particularly, it relates to the use of milling equipment such as media milling, rotor stator mixers, high-speed dispersers and fluid jet mills, to agglomerate an unstable or destabilized slurry to a specific structure.

### TECHNICAL BACKGROUND

Dispersions of fine particles are often unstable, i.e. the particles tend to aggregate or agglomerate in a disorganized fashion. Often powders are comprised of assemblies of particles rather than single particles, and these particles are usually aggregated. Such assemblies are of limited commercial use and have to be processed further. Such processing is often difficult because, in aggregates, the particles are held tightly together e.g. sintered, and in a random structure. Agglomerates are useful structures in that they are easier to redisperse as the contact area between the particles is less, and the particles are held in position by weaker interparticle forces.

This invention relates to the dispersion of powders in liquids. The text “Dispersion of Powders in Liquids” edited by G. D. Parfitt (3^{rd} Edition, Applied Science Publishers, London & New Jersey, (1981) describes the typical art in this dispersion process. As Parfitt describes the process in Chapter 1 of this text, the dispersion process has three stages, wefting of the pigment into the liquid, dispersion of the particles into colloidal particles, and stabilization of the particles against flocculation. The mill used in the dispersion process accomplishes the first two parts of this process, and various chemical additives are used to stabilize the dispersion against flocculation. It is commonly understood, as described by Parfitt, that particles dispersed in a liquid will rapidly agglomerate into large particle clusters due to Brownian motion of the particles and attractive Van der Waals forces between the particles if these additives are not added. These additives stabilize the dispersed particles either by imparting charge to the surface of the particles, thereby creating an electrostatic repulsion, which keeps the particles apart. Another example is where additives adsorb to the surface of particles and keep the particles physically apart (usually called steric stabilization).

In many applications, the goal of the dispersion process is to disperse particles to as fine a size as possible. There are applications where this is usually not the desired goal. For instance, if one is adding electrically conducting particles to a slurry used in a paint that needs to be conductive (for example an automotive electrocoat); it is desired to have the particle form conductive networks. For this to happen with the fewest number of particles, the particles must be neither fully dispersed (where they will not interact) nor agglomerated into very large clumps (which will require a large number of particles to achieve the desired conductivity goals).

There are some examples known where materials are milled according to the well-known processes described above and then re-agglomerated to form products. One example is found in patent WO9528435(A1), which describes the making of a powder coating material by media milling a slurry of plastic particles in water and then destabilizing the slurry by heating it to form larger particles suitable for powder coating, prior to removing the water by drying. The agglomeration is a post-treatment of the milled slurry and does not consider using additional milling to help control the structure formed. Another example is found in Hersey and Krycer “Fine Grinding and the Production of Coarse Particulates” Chemical Engineer V351 (1979) where they describe the use of a ball mill to granulate pharmaceutical compounds. The process they describe involves dry grinding pharmaceutical materials to a fine size and then allowing it to agglomerate to a larger size in order to form granules. They describe this and similar processes as balancing between agglomeration forces and the de-agglomeration of the mill. They describe the well-known use of surfactants and surface charge to control agglomeration, but do not mention the idea of deliberately disrupting the stabilization to form agglomerates of a specific character. A similar process is found in an article by Liu and Lin titled “Influence of ceramic powders of different characteristics on particle packing and sintering behavior” Journal of Materials Science 34 (1999) 1959-1972, which describes the agglomeration of ceramic powder in a ball mill to control the pore density of green tape. As is typical of these processes, the agglomeration is relatively uncontrolled and simply relies on milling time to establish a desired structure.

In various metal working industries, the use of milling to sinter metallic powders (where sintering is essentially a specialized form of aggregation) is well-known. U.S. Pat. No. 6,402,066 describes a typical process where metal powders are aggregated into large particles and eventually form flakes. The aggregation and flake formation is sometimes controlled by adding a surfactant. A similar process is described in He and Schoenung “Nanostructured Coatings” Materials Science and Engineering A336 (2002) for several metal powders. They describe combinations of milling conditions and solvent selections that lead to different sintered particle morphologies, either powder or flake, depending on conditions. In these typical processes, the powders are never stabilized prior to the process step at which sintering begins.

The present invention starts with an already-dispersed particle slurry, to create a slurry of larger agglomerates with a specific structure, and optimizes it for a given application by balancing the re-agglomeration tendencies of a de-stabilized dispersion and the re-stabilizing effects of continued milling.

### SUMMARY OF THE INVENTION

The present invention relates to a process for producing particle agglomerates, said process comprising:
a) forming particles in situ in a liquid to form an unstable slurry;
b) processing said slurry with a shear device controlled by process parameters selected from the group consisting of flow rate, energy input, configuration, geometry, media size, media type, pressure drop, temperature, and combinations thereof; and
c) forming particle agglomerates having a desired size, size distribution, structure and stability.

The present invention also relates to a process for producing particle agglomerates, said process comprising:
(a) dispersing particles in a liquid to form an unstable slurry;
(b) processing said slurry with a shear device controlled by process parameters selected from the group consisting of flow rate, energy input, configuration, geometry, media size, media type, pressure drop, temperature, and combinations thereof; and
(c) forming particle agglomerates having a desired size, size distribution, structure and stability.

The present invention also relates to a process for producing particle agglomerates, said process comprising:
(a) destabilizing a stable slurry comprising particles to form an unstable slurry;
(b) processing said slurry with a shear device controlled by process parameters selected from the group consisting of flow rate, energy input, configuration, geometry, media size, media type, pressure drop, temperature, and combinations thereof; and
(c) forming particle agglomerates having a desired size, size distribution, structure and stability.

The present invention also relates to the particle agglomerates and products made from them.

### BRIEF DESCRIPTION OF THE DRAWINGS

FIG. 1 is a graphical representation of DLVO interaction energies as a function of salt concentration for Ludox® and KNO₃.

FIG. 2 is a cartoon depicting the agglomeration of particles.

FIG. 3 is a cartoon depicting the production of daughter particles from parent particles.

FIG. 4 is a graphical representation of the stability ratio for Ludox® in KNO₃.

FIG. 5 is a graphical representation of the measurement of perikinetic agglomeration of Ludox® at various concentrations of KNO₃.

FIG. 6 is a graphical representation of the orthokinetic agglomeration kinetics of Ludox® at different shears.

FIG. 7 is a graphical representation of agglomeration values of Ludox® in KNO₃.

FIG. 8 is a graphical representation of small angle neutron scattering (SANS) of Ludox®.

FIG. 9 is a graphical representation showing the increase of the fractal dimensions of Ludox® with time.

FIG. 10 is a graphical representation comparing small angle neutron scattering and light scattering experiments for Ludox®.

FIG. 11 is a graphical representation showing fractal dimensions for 1 wt % Ludox® in 1 M KNO₃ as a function of time.

FIG. 12 is a graphical representation showing fractal dimensions for 5 wt % Ludox® in 0.4 M KNO₃ as a function of time.

FIG. 13 is a graphical representation of agglomeration of Ludox® as a function of [KNO₃] for various times in a shear device.

FIG. 14 is a graphical representation of the viscosity of a Ludox® dispersion over the course of controlled agglomeration.

### DETAILS OF THE INVENTION

In the present processes the following definitions and descriptions apply.

By “slurry” is meant a dispersion of particulates in a liquid. See, for instance, Dispersing Powders in Liquids, by R. D. Nelson, Elsevier 1988, p. 13.

By “stable slurry” is meant a dispersion of particulates, which can be either primary particles or agglomerates, the size and structure of which does not change over the pertinent time scale. This time scale can be with respect to the time of the processing, or if applicable to the product, then refers to the shelf life of the product.

By “unstable slurry” is meant the opposite of “stable slurry” as described above.

By “agglomerate” is meant groupings of associated or connected particles where the surface area of the agglomerate is similar to the sum of the individual component particles. The size of the particle agglomerates can range from the size of the primary particles (generally in the nanometer size) up to hundreds of micrometers in size. The particle size distribution can be unimodal or multimodal, and again can range between nanometer and hundreds of micrometers. Agglomerates may or may not exhibit a fractal structure. Fractal, or self-similar structures, have mass fractal dimensions (the power law relating the mass of the agglomerate to its characteristic size) ranging from 1, which characterizes a linear chain of connected particles, to a maximum of 3, which constitutes a dense, solid body without internal structure (i.e, a solid sphere for example). In this context fractal dimensions are used to describe the structure of agglomerates as described in Hiemenz & Rajagopalan “Principles of Colloid and Surface Chemistry” 3rd Ed, 1997.

By “destabilization of the slurry” is meant a change in the composition or conditions of the slurry that results in particles or agglomerates to have the propensity to increase in size.

By “shear device” is generally meant any device that imposes a velocity gradient on a fluid. This can be done mechanically by exposing the fluid to two or more surfaces that are moving with respect to each other. When the surfaces move with respect to one another, they create a velocity gradient in the fluid in the gap between the surfaces and therefore the fluid is sheared. Non-limiting examples of shear devices include: an agitator in a tank; a rotor-stator mixer; concentric cylinders with fluid in the gap between (also known as the Couette geometry); Couette with paddles or vane geometries, parallel plates, moving independently of one another; cone and plate geometry; ploughs and/or scrapers; pumps. These examples include commonly-named devices such as, but not limited to, a mill, a high pressure homogenizer, a rotor-stator mixer, a turbine mixer, a paddle mixer, a marine blade mixer, and a scraper blade mixer, Alternately, a velocity gradient can be created by flowing a fluid through a conduit or by creating relative motion in a fluid body. Non-limiting examples include: pumping a fluid through a pipe or channel; introducing a jet of fluid into a body of fluid; creating a swirling or random movement in a fluid (e.g., by shaking).

The “energy input” of the shear device is important, and can be defined as the Kw/Kg of material dispersed. Typically, the range would be between about 1 and about 100,000 Kw/Kg, depending on the process and/or dispersion objective.

Shear devices can use media. Typically, the media can be made of glass, specialty ceramics including by not limited to zirconia, yttrium-stabilized zirconia, other stabilized zirconias, zirconia silica, plastics such as nylon and polyurethanes, and silicas such as sand. Typically, the size for such media is between about 0.05 micrometers to about 5 millimeters.

By “improved solid-liquid separation” is meant the separation of solid particles from a liquid where the improvement can be quantified by means of improved filterability, improved sedimentation, or the like.

“Improved filterability” can be quantified by measuring one or more of the following non-limiting parameters. Flow rate through a porous material is a measure of the permeability and ease of flow of the liquid through the filter cake. Higher flow rates are preferred to increase the productivity. Generally, the flow rate can be from about 1 mL/min to 1000 L/min. Solids retention is quantified by the percentage of insoluble solid particles retained by filtration. Also, the clarity of the filtrate is important if the filtration process objective is to remove solid particles from a liquid. The clarity can be quantified by the insoluble solids percentage or by turbidity measurements through light backscattering techniques. Additionally, dewatering or demoisturing is the removal of liquids out of a porous solids system by gas displacement or by reduction of the porosity through compression. Filtration pressure drop or pressure loss refers to the loss of pressure caused by fluid friction in the porous system. This is generally on the order of about 1 to about 30 psi. Cake permeability is the flow resistance of a porous system and can be determined in a filter test using the Darcy equation or other empirical relationships commonly found in the pertinent art.

“Improved sedimentation” can be quantified by measuring one of the following non-limiting parameters. The sedimentation rate refers to the settling velocity of solid particles in a liquid due to gravitational or centrifugal force. For a single spherical particle in laminar flow, the settling velocity can be calculated by Stokes law. For irregular shaped and agglomerated particles and at higher concentrations other empirical relationships can be used to estimate the sedimentation behavior. Also, bulk behavior describes the handling properties of the particulate solids (sediment or filter cake, for example) after the solid-liquid separation process. The bulk behavior can range from slurry-, paste-, clay-, wet sand-, to dry powder-like and variations in between. Density is defined as the ratio of mass to volume. The clarity of the supernatant is important if the sedimentation process objective is to completely remove solid particles from a liquid. The clarity can be quantified by insoluble solids percentage or by turbidity measurements through light backscattering techniques.

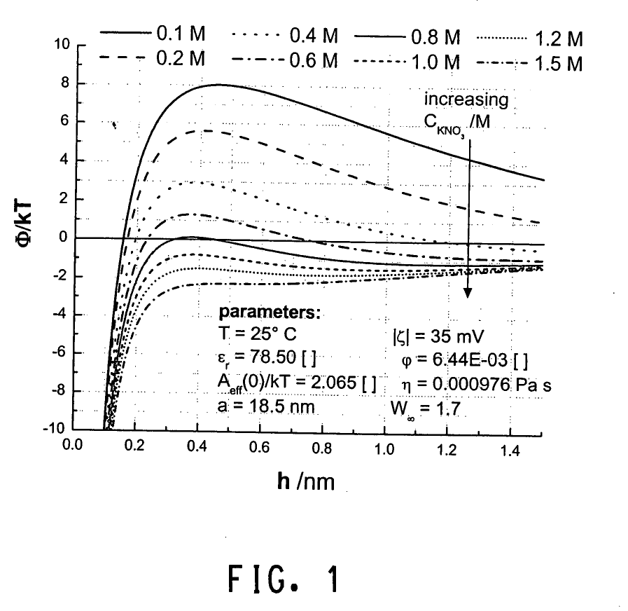

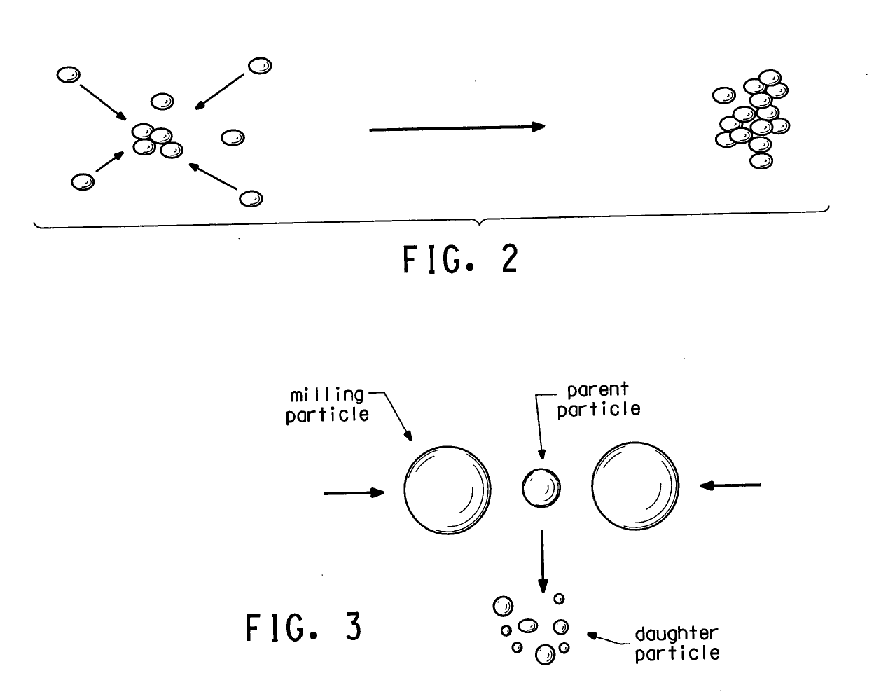

The method disclosed herein is novel in that it produces agglomerates of controlled size and size distribution (including fractal dimension of fractal agglomerates) of nanoparticles. The method is based on the difference in activation energies for shear-induced or orthokinetic agglomeration, Brownian or perikinetic agglomeration, and shear-induced break up. This is illustrated by the results of a DLVO calculation (FIG. 1) appropriate for 50 nm silica particles in water, showing that the energy required to drive particles together, ΔEᵢₙ, is much lower than the energy required to pull particles out of the barrier, ΔEout. From this it can be seen that the theoretical critical coagulation concentration (CCC) is around 0.8 M KNO₃ with good agreement between theory and experiment. The hydrodynamic forces available to pull particles out of the primary minimum (agglomerated state) scales with the hydrodynamic radius of the agglomerate. Consequently, milling will drive particles together until large enough agglomerates are formed (FIG. 2), at which point a substantial rate of agglomerate breakage will occur (FIG. 3). When the average particle size becomes large enough, the rates of agglomeration and breakage will balance and a steady-state agglomerate size and size distribution will be achieved in a controllable manner.

The control of both the particle size and particle size distribution of agglomerates of nanoparticles can be achieved in a stirred media mill by controlling the rate of particle agglomeration relative to agglomerate breakup. These rates are shown to be a function of the interparticle forces, which can be understood within the context of colloid science (DLVO theory, B. V. Deryaguin and L. D. Landau, Acta Physicochim URSS, 14, 633 (1941), E. J. W. Verwey & J. Th. G. Overbeek “Theory of the Stability of Lyophobic Colloids”, Elsevier, Amsterdam (1948)).

FIG. 1 shows the calculated DLVO interaction potential for 1 wt % Ludox® colloidal silica (W. R. Grace and Co., Columbia, Md.) and 0.4M KNO₃. In the figure, the following symbols are used:

εᵣ=dielectric constant of the liquid

βA_{eff}=product of coagulation kernel and Hamaker constant

a=particle radius

|ζ|=magnitude of the zeta potential

φ=solids volume fraction

η=viscosity of the liquid

W_{∞}=stability ratio in rapid coagulation

Φ=interparticle interaction potential in units of kT

h=interparticle separation

The DLVO interaction is calculated using the equations described in the references cited above.

Nanoparticles in a stirred media mill are likely in turbulent shear (orthokinetic). It is known that size reduction in these mills is limited by the so called “grind limit”. Studying the agglomeration of nanoparticles in an Annular Gap Mill enabled tests of the influence of factors that affect colloidal forces and hydrodynamic forces upon the agglomeration or stability of that dispersion.

Experimental determination of the critical coagulation concentration is accomplished by measuring the agglomerate radius as a function of salt concentration and the CCC is the concentration at which the agglomerate size plateaus, in this case 1M KNO₃.

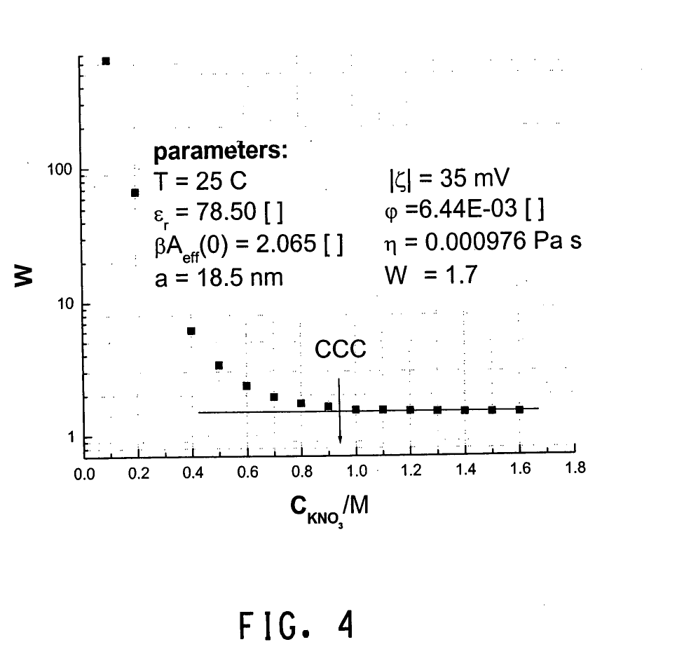

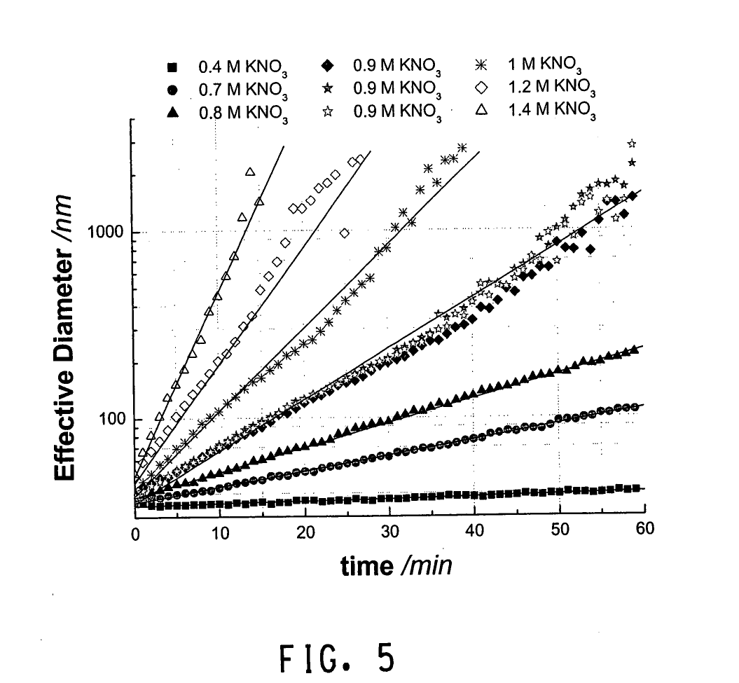

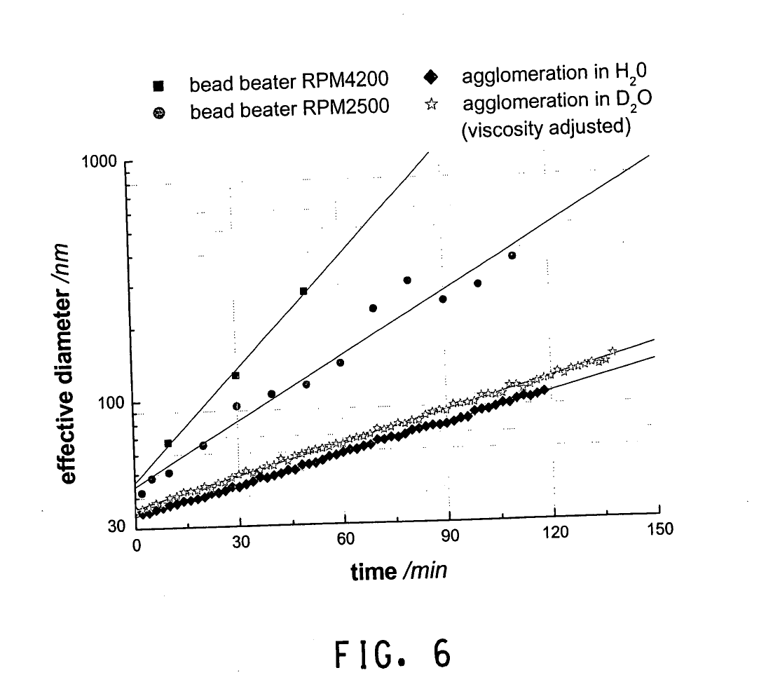

The stability ratio, W, is determined using the Prieve and Ruckenstein approximation and the rapid coagulation stability ratio, W_{inf} taken from Russel, Savile and Schowalter “Colloidal Dispersions”, Cambridge University Press, Cambridge, 1989, assuming the same Hamaker constant as for polystyrene in water (FIG. 4). Perikinetic agglomeration kinetics were measured by light scattering starting with Ludox® of primary particle size of 37 nm and found to be reaction limited agglomeration (FIG. 5).

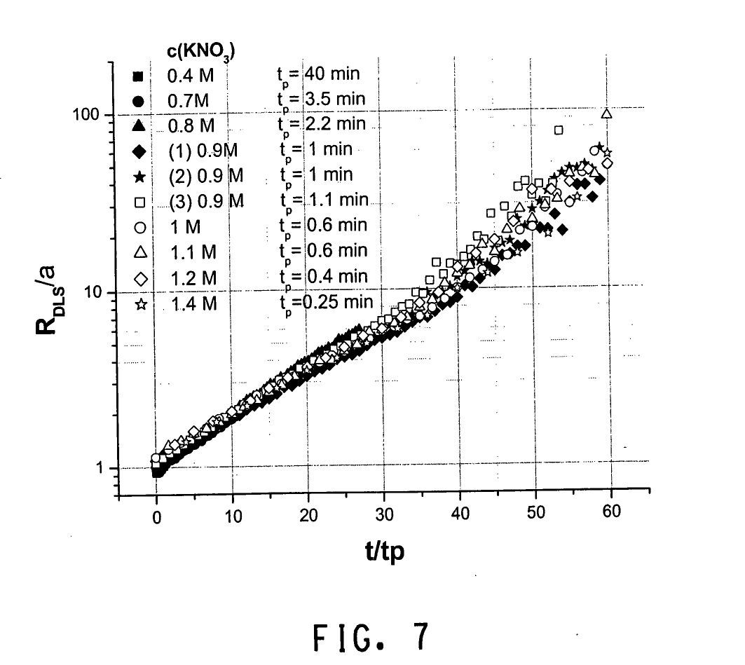

The measurement of orthokinetics was done with different shear rates and demonstrate that shear induced agglomeration is much faster than Brownian agglomeration. These agglomeration data can be reduced to a master curve (FIG. 7).

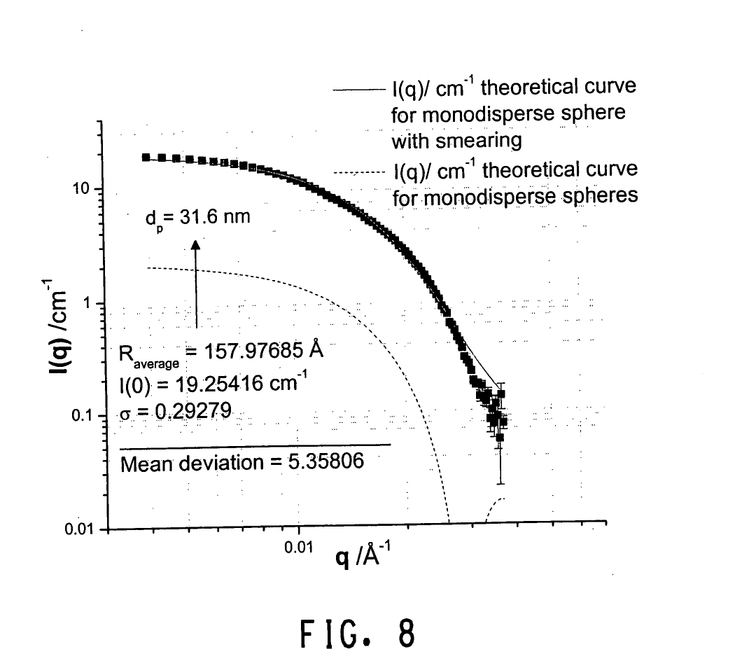

Small angle neutron scattering study of the particles shows the shape of the primary particles to be close to spherical. The scattering intensity of fractal structures is the product of that for homogeneous spheres and a structure factor (FIG. 8). The structure factor is calculated according to J. Teixeira, J. Applied Crystallography, 21, 781 (1988).

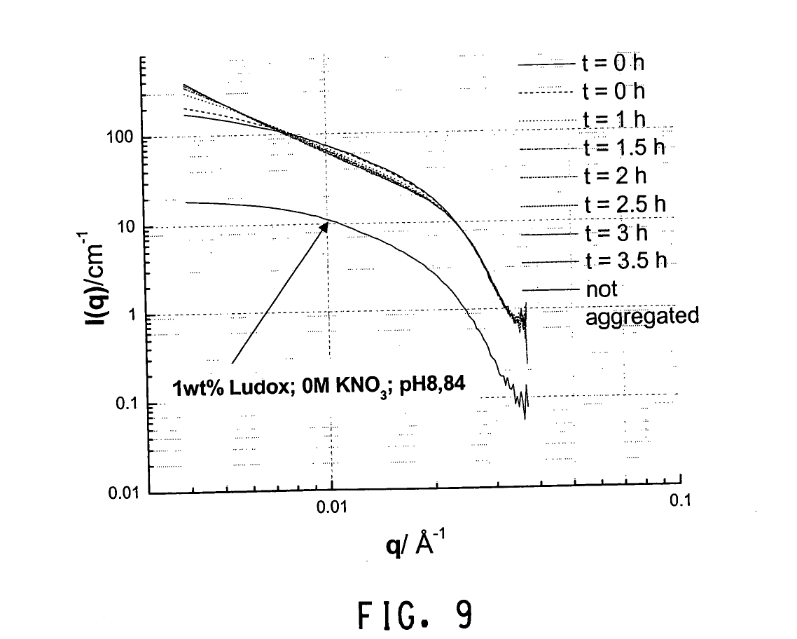

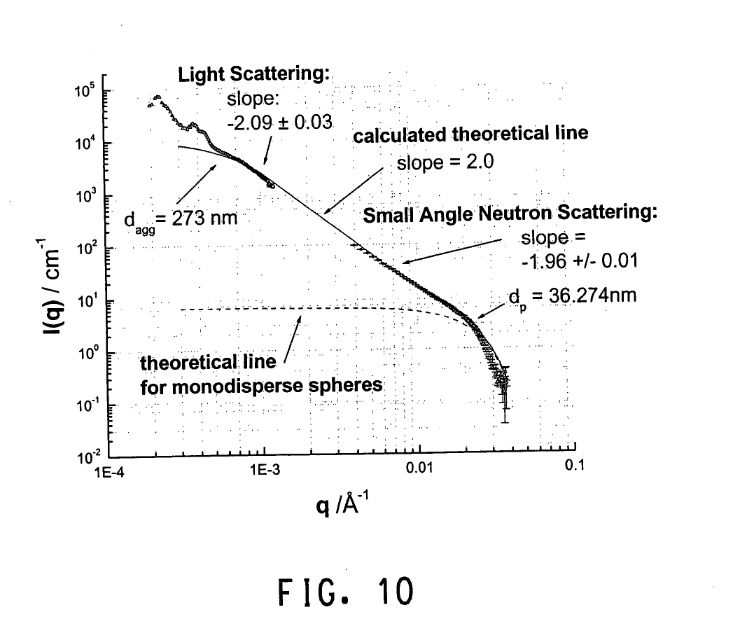

Plotting these data shows that the fractal dimension is increasing with agglomeration time, which can be interpreted as non fractional order on the length scale of the primary particles. See FIG. 9.

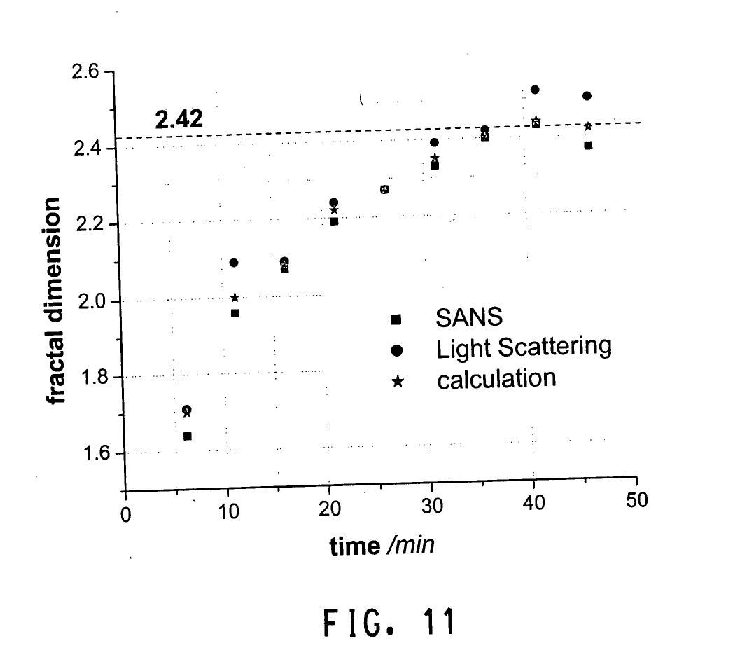

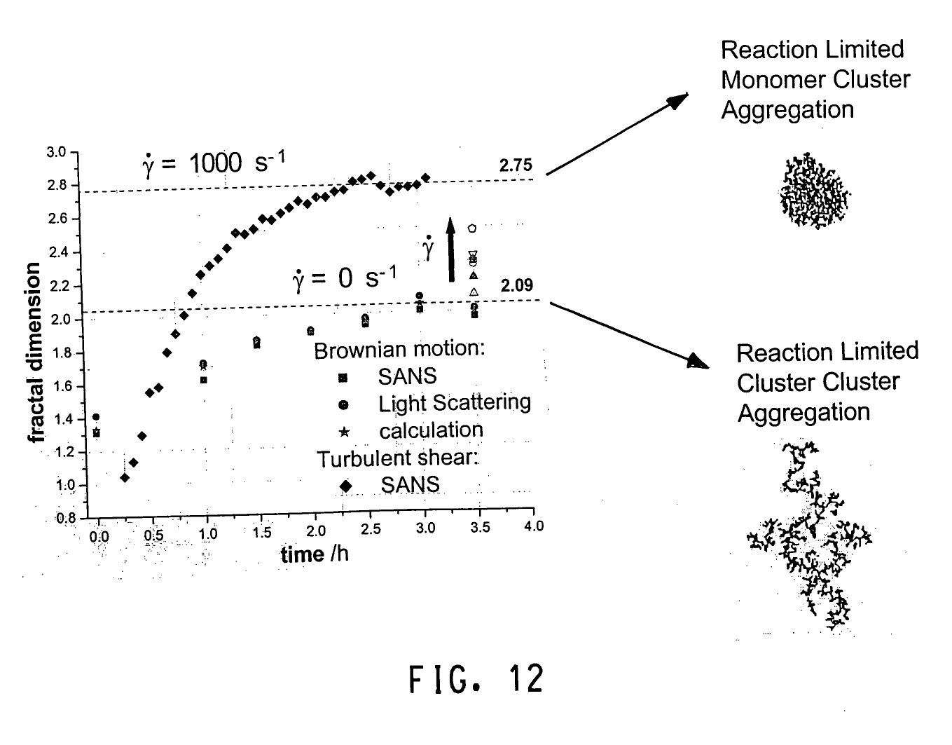

Finally putting the small angle neutron data (FIG. 10) together with shifted light scattering data enables fractal dimension, agglomerate size and primary particle size to be determined. See FIG. 11.

Different structures of agglomerates are described by P. C. Hiemenz and R. Rajagopalan: “Principles of Colloid and Surface Chemistry”, 3^{rd} ed, Marcel Dekker, New York, 1997.

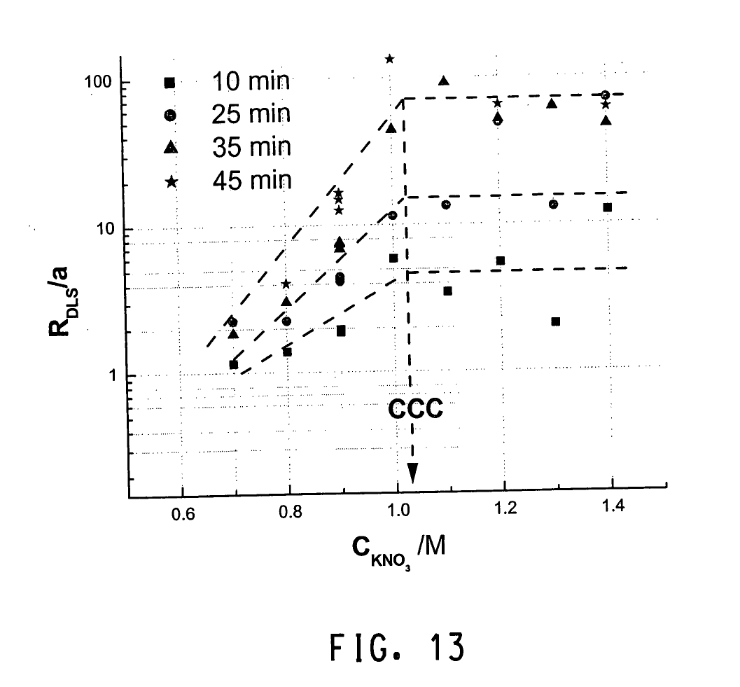

Finally the fractal dimensions for the Brownian agglomeration are plotted in FIG. 12. The fractal dimension approaches 2.42 for long times and corresponds to a diffusion limited monomer cluster agglomeration.

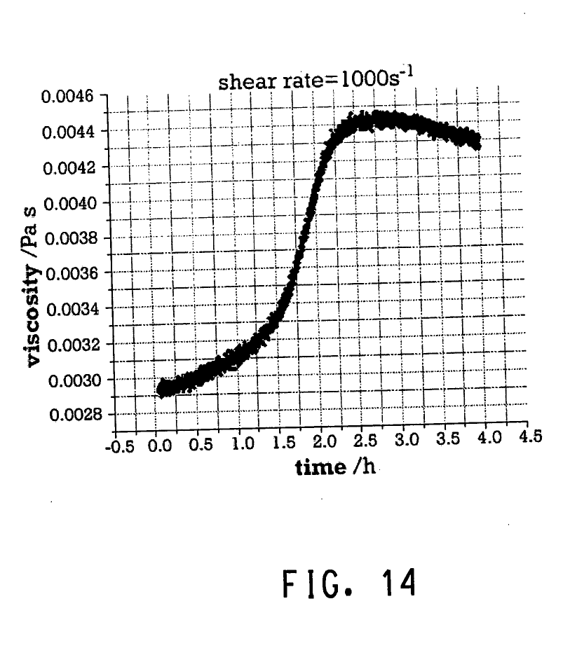

At low salt concentrations and low shear the growth model is reaction limited cluster-cluster agglomeration, whereas in turbulent shear flow it becomes reaction limited monomer cluster agglomeration. Shearing after Brownian agglomeration leads to densification of the agglomerates (FIG. 13).

The remaining figure (FIG. 14) shows the viscosity development during the agglomeration during which the viscosity rises with the particle growth.

Once an unstable slurry is achieved (either by destabilizing a stable slurry, by beginning with an unstable slurry, or forming particles in situ in a liquid to form an unstable slurry), it is processed with a shear device. The shear device can be any device that imparts shear to the slurry, with non-limiting examples of such devices being mills (e.g., media mills, stirred media mills, colloid mills, microfluidizer mills, rotor-stator mills, etc.), and mixers (turbine, paddle, marine blade, etc.). Stirred media mills have been shown to be particularly useful in this invention.

The processes described above and in the references disclosed herein can be applied to other materials and end-uses. The surface chemistry of the particles can be tailored by adjusting factors including, but not limited to, the following: surface potential (via pH, salt type, surfactant); ionic strength (via salt concentration and type, surfactant); counterions, oligomers, polyelectrolytes, block copolymers, macromonomers, solvency of the dispersed phase, and steric stability (via surfactant, grafted or adsorbed polymers or macromolecules, or counterions).

The rheological properties of the slurry are important in the present invention. These properties can be modified by adjusting one of more, alone or in combination, of the following parameters. One such parameter is particle loading, which is a measure of the solids content in a solid-liquid mixture. For a mass-related value, this is the ratio of solids mass and the total mass of the solid-liquid system. Slurry particle loading is generally between about 1% and 70% by weight. Another parameter is continuous phase viscosity, which is the viscosity of the pure liquid phase without particles. Another parameter is the addition of additives, where additives are defined as substances that substantially change the rheological properties of the system. Non-limiting examples of such additives include hydrocolloids, proteins, polymers, surfactants and salts. Temperature and particle size distribution are also key parameters. The temperature is generally between about 10° C. and about 120° C.

The solvency of the continuous phase is also an important parameter, and is generally defined using solubility parameters (See for example Hansen Solubility Parameters, Charles Hansen, CRC Press, 2000). These generally have a polar, a non-polar, and a hydrogen bonding component, and define the solvency of the system of a given continuous phase or mixture of continuous phases. When two continuous phases are mixed the solvency of the system is changed by changes in one or more of the solubility parameters. Even small changes on the order of +/−0.1 units can change the phase equilibria of other dissolved materials, such as dispersants, and therefore affect the dispersion stability.

By manipulating the particle stability and agglomeration factors described above, and balancing the various parameters that are adjusted thereby, particles of the desired size distribution and structure can be formed. Regular colloidal dispersion theory and practice, as mentioned above, provides the framework for the particle stability portion of the balance, while milling theory and practice provides the framework for the agglomeration portion. For example, increasing the particle size of the agglomerates could be achieved by adding salt to the dispersion. The same goal could be also be achieved by decreasing the specific energy in the mill.

Particles of a variety of structures can be made by the processes of the present invention. These include but are not limited to microstructured particles, an example of which is a core-shell structure.

The present process can be used to prepare food particles. By “food particles” is meant edible particles that are insoluble in the liquid in which they are dispersed. They can be in crystalline or amorphous form. The composition of such particles includes but is not limited to: amino acids, peptides, proteins, lipids, carbohydrates, aroma and flavor substances, vitamins, minerals, flavor enhancers, sugar substitutes and sweeteners, food colors, acids and salts thereof, bases and salts thereof, antimicrobial agents, antioxidants, chelating agents, surface active agents (emulsifiers), thickening and stabilizer agents, humectants and plasticizers, fat substitutes, anticaking agents, and bleaching and clarifying agents.

The present process can be used to prepare protein particles. By “protein particles” is generally meant precipitated or crystallized particles of protein or protein mixtures. The protein particle may also contain other components such as lipids or carbohydrates (e.g., lipoproteins or glycoproteins).

The present process can be used to prepare pharmaceutical particles. By “pharmaceutical particle” is generally meant, but not limited to, vitamins, supplements, minerals, enzymes, proteins, peptides, antibodies, vaccines, probiotics, bronchodilators, anabolic steroids, analeptics, analgesics, anesthetics, antacids, antihelmintics, anti-arrthymics, antibiotics, anticoagulants, anticolonergics, anticonvulsants, antidepressants, antidiabetics, antidiarrheals, anti-emetics, anti-epileptics, antihistamines, antihormones, antihypertensives, anti-inflammatories, antimuscarinics, antimycotics, antineoplastics, anti-obesity drugs, antiprotozoals, antipsychotics, antispasmotics, anti-thrombics, antithyroid drugs, antitussives, antivirals, anxiolytics, astringents, beta-adrenergic receptor blocking drugs, bile acids, bronchospasmolytic drugs, calcium channel blockers, cardiac glycosides, contraceptives, corticosteriods, diagnostics, digestives, diuretics, dopaminergics, electrolytes, emetics, haemostatic drugs, hormones, hormone replacement therapy drugs, hypnotics, hypoglycemic drugs, immunosuppressants, impotence drugs, laxatives, lipid regulators, muscle relaxants, pain relievers, parasympathicolytics, parasympathicomimetics, prostagladins, psychostimulants, sedatives, sex steroids, spasmolytics, sulfonamides, sympathicolytics, sympathicomimetics, sympathomimetics, thyreomimetics, thyreostatic drugs, vasodialators, and xanthines.

The present process can be used to prepare agrochemical particles. By “agrochemical particle” is generally meant, but not limited to, herbicides, insecticides, acaricides, miticides, fungicides, nematicides and plant growth regulators. Alternatively, the solid crop protection particle of the present invention may be a crop protection microbial. Such microbials include beneficial viruses, bacteria, nematodes, fungi and protozoa.

The present process can be used to prepare pigment particles. By “pigment particle” is generally meant, but not limited to, any particle that imparts color or other change of appearance to materials by a combination of light absorption and light scattering.

The present process can be used to prepare conductive films. By “conductive films” is meant any film that conducts electricity or heat much more readily than non-conductive films. The conductivity of electrically conductive films may be 100 times or more greater than that of non-conductive films. Thermal conductivity of the films may be 10 times greater than that of non-conductive films. These films may comprise silver.

### Analytical Methods

The agglomeration kinetics is measured using dynamic light scattering (DLS, ZetaPals from Brookhaven Instruments Corp.) as a function of particle and electrolyte concentrations. Further information on the agglomeration process and the structure of the agglomerates are also obtained from small angle neutron scattering (SANS, at the 20 MW research reactor at NIST's Center for Neutron Research using instrument NG-3 and is fully described by Glinka et al. in Journal of Applied Crystallography 31, 430 (1998)) and rheo-optical light scattering (ROA,) experiments. The measured quantities can be used to determine parameters in agglomeration and breakup kernels in a particle population balance model, that includes breakup and agglomeration mechanisms and is modified to include fundamental mechanisms of colloidal stability.

A variety of mills can be used for the process as described herein, non-limiting examples of which include media, milling, rotor stator mixers, high-speed dispersers, high pressure media mills and fluid jet mills.

Unless otherwise specified, all chemicals and reagents are used as received from Aldrich Chemical Co., Milwaukee, Wis.

### EXAMPLES

### Examples 1-4

Determination of Agglomeration Rate and Particle Size

### Example 1

The particle agglomeration rate at different shear stresses was measured by dynamic light scattering (DLS). The colloidal silica (Ludox TM-50) was diluted to 5 wt.% in aqueous KOH to a pH of 8.84 and 0.2 M KNO₃ and the suspension sheared in a high shear rheometer at 1000 s⁻¹ for this purpose. A sample of the suspension was drawn at different times and the size of the agglomerates was measured with DLS. Perikinetic agglomeration was also measured for each sample. The sizes of the agglomerates were stable without applied shear stress.

### Example 2

Example 1 is repeated with a salt concentration of 0.4 M KNO₃ instead of a 0.2 M KNO₃. At 0.4 M KNO₃ the energy barrier ΔEᵢₙ is much lower than the energy barrier at 0.2 M KNO₃. The agglomeration rate is measured in the same way and is much faster.

### Example 3

The next experiment reduces the energy barrier ΔEₒᵤₜ by adding a non-ionic surfactant to the system. By reducing the energy barrier, the final size of the agglomerates is controlled. The particles can overcome the barrier easier when it is reduced due to a layer of surfactant around the particles. For this reason, the final particle size is smaller.

### Example 4

After the controlled experiments in the rheometer are done successfully, the shear stress is applied to the dispersion in a stirred media mill instead of the rheometer. The agglomeration and breakage rate are measured with DLS as described above.

### Example 5

Production of a Conductive Film

A stable carbon black dispersion was produced using 10 wt % of a conductive carbon black, 5 wt % acrylic dispersant, and 75 wt % xylene. This was produced in a media mill process by recirculating the slurry through the mill so that the slurry had a residence time of 30 minutes in the mill. The mill had an 85% loading of 0.6-0.8 mm zirconia silica media from SEPR (S. E. Firestone Assoc., Russell Finex Inc., Charlotte, N.C.), and was run at a tip speed of 14 m/s.

After the dispersion was produced, it was destabilized by adding a solution of a 50/50 mixture of butyl acetate and a poly(methylmethracrylate)-based binder resin. The ratio of dispersion to resin solution was 1:4 so that the ratio of carbon black to binder resin was 1 to 20. This mixture was processed in a media mill by recirculation such that the slurry had a residence time of 5 minutes in the mill. The mill had an 85% loading of 1.0-1.2 mm zirconia silica media from SEPR (S. E. Firestone Assoc., Russell Finex Inc., Charlotte, N.C.) and was run at a tip speed of 10 m/s.

These conditions gave an optimal electrical conductivity through the thickness of the film when the resulting mixture was drawn down into a 2 mil thick film. Variations in these conditions resulted in lower film conductivity.

### Example 6

Protein Particle Agglomeration

Soy Protein Extraction

The soy protein source used for all experiments was ground defatted soy flakes. Extraction was carried out at 1:10 soy flour to water ratio at room temperature (21-23° C.). The pH of water is adjusted to about 8.5 with 1N NaOH and 0.03M of sodium bisulfite (Na₂S₂O₅). 30 g of soy flour was added to 300 ml of water and stirred with an overhead impeller for 1 hr in a constant temperature water bath. The suspension was centrifuged for 30 mins at 15000 rpm in a Beckman Coulter (Fullerton, Calif.) Allegra 21 R Centrifuge. The final pH of the protein extract was approximately 7.5. The final pH of the extract when no sodium bisulfite was added was approximately 6.5.

Soy Isolate Agglomeration in the Rheometer

Soy isolate agglomerates were formed by lowering the pH of the protein extract to 4 with 1N HCl. The agglomeration was done in a controlled shear field of a couette cylinder geometry using a Paar Physica MCR300. The agglomeration was done at a shear rate of 10 1/s for low end and 3000 1/s for the high end. Acid was added with a pipette directly into the couette cylinder under shear. After acid addition the shear was kept for 5 minutes at constant shear rate. The temperature was kept constant (22° C.) by the rheometer temperature controller. Samples of the agglomerates were characterized by light microscopy and psd.

The low shear product was comprised of weak open flocs that settled slowly and filter poorly with significant entrainment. With increasing shear rate the agglomerates became less porous and when sheared at 3000s-1 with the wide gap the agglomerates became denser and around 10-50 μm. The structured agglomerates filtered efficiently.

### Example 7

Crop Protection Chemical Agglomerate Formation

Xylene (86 g), 40.4 g isopropyl alcohol were mixed in a beaker and heated to 75° C. To this mixture was added 30 g of famoxate (DuPont Co., Wilmington, Del.). All the famoxate dissolved under these conditions. The solution was transferred to the Paar Physica MCR300 rheometer using concentric cylinder geometry (CC27 bob radius 13.33mm, CC27 cup radius 14.46mm, CC17 bob radius 8.33 mm).

A low shear rate example was done with a CC27 bob and CC27 cup in a rheometer, and was run at 10 sec−1, 75° C. for about 6 minutes. The shear stress was steady at 6 to 8 mPa. The temperature was ramped from 75° C. to 20° C. over 15 minutes.

A high shear rate example was done with the CC27 bob and CC27 cup in a rheometer. It was started at 3300 rpm, then the temperature was ramped from 75° C. to 20° C. over 15 minutes.

A high shear turbulent example was done with CC1 7 bob and CC27 cup in a rheometer. The RPM (not shear rate) was controlled at a maximum of 3300 rpm. The temperature was held at 75° C until the shear stress leveled out at 250,000 mPa (about 2 minutes). Then the temperature was ramped from 75° C to 20° C in 15 minutes.

The low shear rate example was largely still dissolved at the end of the cooling cycle; solute crystallized under the microscopy in the characteristic needle shaped particles typical of famoxate. Meanwhile with high laminar shear the particles agglomerated into spherical particles comprising needles radiating from the center. The turbulent shear example formed large particles of unclear form, but not needle like having little or no free continuous phase (unlike the previous examples).

### Example 8

Silver Particles

Nanoparticles of silver are prepared by reducing silver nitrate solution with sodium borohydride solution in a quiescent vessel. Polyvinylpyrollidone (PVP) was present to stabilize the resulting suspension. The particle size distribution was very narrow, with a median particle size of 20 nm. Repeating this process without the polyvinylpyrollidone resulted in larger particles. Repeating this pair of experiments in a vigorously stirred vessel resulted in larger agglomerates in both cases.

| Sample | PVP | Agitation | d10 (nm) | d50 (nm) | d90 (nm) | Z-AVG |
|---|---|---|---|---|---|---|
| 10A | No | Weak | 19.0 | 28.7 | 1022.8 | 192.0 |
| 10B | Yes | Weak | 7.7 | 11.3 | 22.2 | 48.3 |
| 10C | No | Vigorous | 99.9 | 694.3 | 1286.8 | 304.9 |
| 10D | Yes | Vigorous | 11.6 | 19.6 | 87.1 | 108.1 |

1. A process for producing particle agglomerates, said process comprising:
a) forming particles in situ in a liquid to form an unstable slurry;
b) processing said slurry with a shear device controlled by process parameters selected from the group consisting of flow rate, energy input, configuration, geometry, media size, media type, pressure drop, temperature, and combinations thereof; and
c) forming particle agglomerates having a desired size, size distribution, structure and stability.

2. A process for producing particle agglomerates, said process comprising:
a) dispersing particles in a liquid to form an unstable slurry;
b) processing said slurry with a shear device controlled by process parameters selected from the group consisting of flow rate, energy input, configuration, geometry, media size, media type, pressure drop, temperature, and combinations thereof; and
c) forming particle agglomerates having a desired size, size distribution, structure and stability.

3. A process for producing particle agglomerates, said process comprising:
a) destabilizing a stable slurry comprising particles to form an unstable slurry;
b) processing said slurry with a shear device controlled by process parameters selected from the group consisting of flow rate, energy input, configuration, geometry, media size, media type, pressure drop, temperature, and combinations thereof; and
c) forming particle agglomerates having a desired size, size distribution, structure and stability.

4. The process of claims 1, 2 or 3, wherein said shear device is selected from the group consisting of an agitator in a tank; a rotor-stator mixer; concentric cylinders with fluid in the gap between; parallel plates, moving independently of one another; cone and plate geometry; ploughs, scrapers; and pumps.

5. The process of claim 4, wherein the shear device is a media mill.

6. The process of claim 5, wherein the media mill is a stirred media mill.

7. The process of claim 4, wherein the shear device is a rotor-stator mixer.

8. The process of claim 4, wherein the shear device is a scraper blade mixer.

9. The process of claims 1, 2 or 3, wherein the agglomerates formed show improved solid-liquid separation.

10. The process of claim 9, wherein the solid-liquid separation is demonstrated by improved filterability.

11. The process of claim 9, wherein the solid-liquid separation is demonstrated by improved sedimentation.

12. The process of claim 3, wherein the destabilization of the slurry is achieved by adjusting the surface chemistry of said particles.

13. The process of claim 12, wherein the surface chemistry of the particles is adjusted by the addition of salts, acids, bases, surfactants, counterions, oligomers, polyelectrolytes, block copolymers, macromolecules, or combinations thereof.

14. The process of claim 12, wherein the surface chemistry of the particles is adjusted by modifying the solvency of the continuous phase.

15. The process of claims 1, 2 or 3, wherein the agglomeration is adjusted by varying the rheological properties of the slurry of step (a), slurry particle loading, the process parameters of the shear device, or combinations thereof.

16. The process of claim 15, wherein the rheological properties of the slurry are modified by adjusting parameters selected from the group consisting of particle loading, continuous phase viscosity, temperature, addition of additives, particle size distribution, and combinations thereof.

17. Conductive films prepared using the particle agglomerates produced by the process of claims 1, 2 or 3.

18. The films of claim 17, wherein the particle agglomerates comprise silver.

19. Particle agglomerates produced by the process of claims 1, 2 or 3, wherein said particles comprise silver.

20. Particle agglomerates produced by the process of claims 1, 2 or 3, wherein said particles comprise gold.

21. Food particles prepared using the particle agglomerates produced by the process of claims 1, 2 or 3.

22. The food particles of claim 21, wherein the particle agglomerates are comprised of amino acids, peptides, proteins, lipids, carbohydrates, aroma and flavor substances, vitamins, minerals, flavor enhancers, sugar substitutes and sweeteners, food colors, acids and salts thereof, bases and salts thereof, antimicrobial agents, antioxidants, chelating agents, surface active agents (emulsifiers), thickening and stabilizer agents, humectants and plasticizers, fat substitutes, anticaking agents, bleaching and clarifying agents, and mixtures thereof.

23. Protein particles prepared using the particle agglomerates produced by the process of claims 1, 2 or 3.

24. Pharmaceutical particles prepared using the particle agglomerates produced by the process of claims 1, 2 or 3.

25. Agrochemical particles prepared using the particle agglomerates produced by the process of claims 1, 2 or 3.

26. Pigment particles prepared using the particle agglomerates produced by the process of claims 1, 2 or 3.

27. Particle dispersions prepared using the particle agglomerates produced by the process of claims 1, 2 or 3.

28. Particles prepared using the particle agglomerates produced by the process of claims 1, 2 or 3, said particles comprising a core-shell structure.
